(19) United States
(12) Patent Application Publication
(10) Pub. No.: US 2005/0152427 A1
(43) Pub. Date: Jul. 14, 2005

(54) Array-type optical device having enhanced pump efficiency

(76) Inventors: Jung-Hoon Shin, Yusong-gu (KR); Nam-Kyoo Park, Seoul (KR)

Correspondence Address: MARGER JOHNSON & MCCOLLOM, P.C., 1030 SW MORRISON STREET, PORTLAND, OR, 97205, US

(21) Appl. No.: 10/507,388

(22) PCT Filed: Mar. 13, 2003
(86) PCT No.: PCT/KR03/00492

(30) Foreign Application Priority Data
Mar. 13, 2002 (KR) 10-2002-0013425

(51) Int. Cl. H01S 3/091; G02B 6/10

(52) U.S. Cl. 372/70; 385/129

(57) ABSTRACT

The present invention relates to an array-type optical device, which can enhance optical pumping efficiency. The major characteristic of the present invention is that the array-type optical device has as many gain medium structures as possible within a beam spot of an optical pumping source or has an increased number of optical pumping sources to irradiate gain medium structures, which enhances optical pumping efficiency.

This application claims benefit of Korean Patent Application No. 2002-13425, filed on Mar. 13, 2002, and PCT/KR03/00492, filed Mar. 13, 2003, which is hereby incorporated by reference.

### TECHNICAL FIELD

The present invention relates to an array-type optical device which receives pumping light from an optical pumping source, and more particularly to an array-type optical device which has as many gain medium structures as possible within a beam spot of an optical pumping source or has an increased number of optical pumping sources to irradiate gain medium structures, in order to enhance optical pumping efficiency.

### BACKGROUND ART

Recently, a side pumping arrangement has been used frequently to pump optical devices such as an optical waveguide amplifier. In the side pumping arrangement, light from a pumping light source is coupled with an input terminal of the optical device, thereby exciting a gain medium within the optical device. It is difficult to apply such a side pumping arrangement to an array-type optical device comprising a plurality of waveguides. If the light from the pumping light source is coupled with input terminals of each waveguides arranged closely to each other, it is difficult to integrate the waveguides, thus increasing the total size of the array-type optical device.

Therefore, in order to overcome the above disadvantages of the side pumping arrangement, a top pumping arrangement has been proposed in which an upper cladding layer formed on an optical waveguide is made of a transparent material transmitting the pumping light, and the pumping light source is positioned above the upper cladding layer.

FIG. 1 is a schematic view illustrating the operation of a conventional top-pumped optical waveguide amplifier employing the top pumping arrangement. With reference to FIG. 1, a lower cladding layer 110 made of silica is formed on a substrate 100, and a core layer made of silica-based substance doped with nano-crystals and rare-earth elements is formed on the lower cladding layer 110. Here, the core layer serves as a waveguide 120. An upper cladding layer 130 made of silica is formed on the waveguide 120. A broad-band light source (not shown) is installed above the waveguide 120 so that pumping light is irradiated from the light source onto the top surface of the waveguide 120. The light inputted into the waveguide 120 creates electrons and holes in the nano-crystals that recombine, thus exciting the rare-earth elements. The input light receives energy from the excited rare-earth elements, is amplified by passing through the waveguide 120, and then outputted from the waveguide 120.

In such a top-pumped optical device using the top pumping arrangement, preferably, a plurality of gain medium structures are included within a beam spot of the optical pumping source, in order to enhance optical pumping efficiency. Accordingly, it is necessary to improve a planar or three-dimensional arrangement of the plural gain medium structures in the array-type optical device so as to effectively use the light from the pumping light source.

### DISCLOSURE OF THE INVENTION

Therefore, the present invention has been made in view of the above problems, and it is an object of the present invention to provide an array-type optical device having an improved arrangement and shapes of a plurality of gain medium structures so that pumping light from an optical pumping source is effectively absorbed into the gain medium structures.

In accordance with a first aspect of the present invention, the above and other objects can be accomplished by the provision of an array-type optical device having enhanced pumping efficiency, comprising: a substrate; a cladding layer having a plurality of valley portions and ridge portions formed on the substrate; a plurality of linear gain medium structures, each formed on the surfaces of the valley portions and the ridge portions of the cladding layer, or inserted in the valley portions and the ridge portions of the cladding layer so as to be separated from their surfaces by designated distances; and a pumping light source disposed above the cladding layer for pumping the gain medium structures by means of light directed downward there from.

Preferably, the cladding layer may be made of a material, which can transmit the light irradiated from the pumping light source.

In accordance with a second aspect of the present invention, there is provided an array-type optical device having enhanced pumping efficiency, comprising: a substrate; a lower cladding layer formed on the substrate; a plurality of linear gain medium structures formed on the lower cladding layer; and a pumping light source disposed above the linear gain medium structures for pumping the gain medium structures by means of light directed downward there from, wherein the linear gain medium structures are densely disposed and curved at their terminals so that other portions of the linear gain medium structures are included in a beam spot of the pumping light source.

Preferably, the array-type optical device may further comprise an upper cladding layer formed on the gain medium structures, and the upper cladding layer may be made of a material which can transmit the light irradiated from the pumping light source.

In accordance with a third aspect of the present invention, there is provided an array-type optical device having enhanced pumping efficiency, comprising: a substrate; a lower cladding layer formed on the substrate; a plurality of linear gain medium structures formed on the lower cladding layer; and upper and lower pumping light sources, each disposed above the upper surfaces of the gain medium structures and below the lower surfaces of the gain medium structures for pumping the gain medium structures by means of light directed downward and upward there from, wherein the substrate and the lower cladding layer are made of a material which can transmit the light irradiated from the pumping light sources.

Preferably, the array-type optical device may further comprise an upper cladding layer formed on the gain medium structures, and the upper cladding layer may be made of a material which can transmit the light irradiated from the pumping light sources.

Further, preferably, the pumping light sources of the array-type optical devices in accordance with the first to third embodiments of the present invention may be LEDs (Light Emitting Diodes).

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view illustrating the operation of a conventional top-pumped optical waveguide amplifier;

FIG. 2 is a schematic cross-sectional view of an array-type optical device in accordance with a first embodiment of the present invention;

FIG. 3 is a schematic perspective view of an array-type optical device in accordance with a second embodiment of the present invention; and

FIG. 4 is a schematic cross-sectional view of an array-type optical device in accordance with a third embodiment of the present invention.

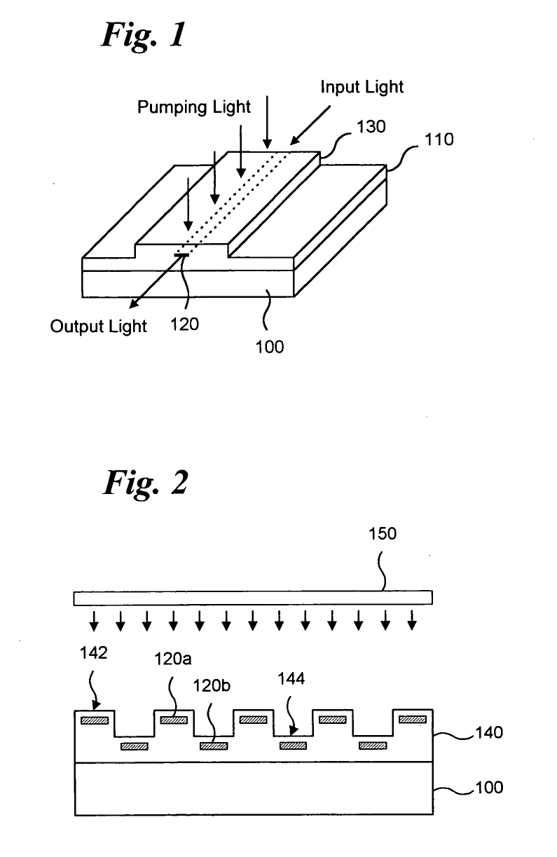

### BEST MODE FOR CARRYING OUT THE INVENTION

Now, with reference to accompanying drawings, preferred embodiments of the present invention are described in detail.

### First Embodiment

FIG. 2 is a schematic cross-sectional view of an array-type optical device in accordance with a first embodiment of the present invention.

With reference to FIG. 2, a cladding layer 140 having a plurality of valley portions 144 and ridge portions 142 is formed on the substrate 100. Here, the height difference between the valley portion 144 and the ridge portion 142 is only approximately 10 μm. Accordingly, in case that a pumping light source 150 disposed above the cladding layer 140 is omitted, the array-type optical device in accordance with the first embodiment of the present invention has a nearly flat configuration. A plurality of linear gain medium structures 120a and 120b are inserted in the valley portions 144 and the ridge portions 142 so that the gain medium structure 120a is separated from the external surface of the ridge portion 142 and the gain medium structure 120b is separated from the external surface of the valley portion 144. The pumping light source 150 is disposed above the external surface of the cladding layer 140 so as to be spaced from the cladding layer 140 by a designated distance, thus irradiating its pumping light onto the linear gain medium structures 120a and 120b. Therefore, the cladding layer 140 is made of a material which can transmit the pumping light irradiated from the pumping light source 150 so that the pumping light reaches the gain medium structures 120a and 120b. Although the plural linear gain medium structures 120a and 120b are inserted in the valley portions 144 and the ridge portions 142 of the cladding layer 140 in this embodiment of the present invention, the linear gain medium structures 120a and 120b may be formed directly on the external surfaces of the valley portions 144 and the ridge portions 142 of the cladding layer 140. The formation of the valley portions 144 and the ridge portions 142 of the cladding layer 140 and the insertion of the plural linear gain medium structures 120a and 120b into the valley portions 144 and the ridge portions 142 are easily achieved by photolithography and etching processes usually employed in the manufacturing of semiconductor devices, and their detailed descriptions are omitted. Such a configuration of the array-type optical device allows an increased number of the linear gain medium structures 120a and 120b to be integrally formed within a beam spot of the pumping light source 150, thereby enhancing optical pumping efficiency.

### Second Embodiment

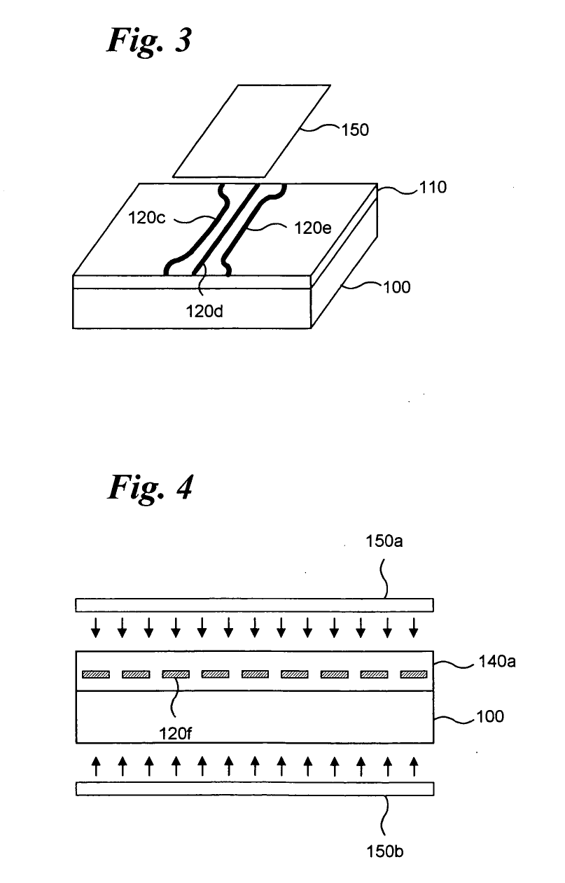

FIG. 3 is a schematic perspective view of an array-type optical device in accordance with a second embodiment of the present invention.

With reference to FIG. 3, the lower cladding layer 110 made of silica is formed on the substrate 100, and a plurality of linear gain medium structures 120c, 120d, and 120e are formed on the lower cladding layer 110. Differently from FIG. 2, the plural linear gain medium structures 120c, 120d, and 120e are formed on the surface of the lower cladding layer 110. Accordingly, the distance between the neighboring gain medium structures 120c, 120d, and 120e at their input and output terminals is widened due to the need to couple them with optical fibers (not shown). In case that the widened state between the neighboring gain medium structures 120c, 120d, and 120e is maintained, it is difficult to include the gain medium structures 120c, 120d, and 120e within the beam spot of the light pumping source 150. In this case, it is difficult to enhance the pumping efficiency of the optical device. Accordingly, the linear gain medium structures 120c, 120d, and 120e of this embodiment of the present invention are curved at their input and output terminals so that the linear gain medium structures 120c, 120d, and 120e at their center portions are closely disposed and included in the beam spot of the pumping light source 150, thus achieving an array-type optical device having enhanced pumping efficiency. Although an upper cladding layer is not formed on the gain medium structures 120c, 120d, and 120e in this embodiment of the present invention, if necessary, the upper cladding layer made of a material which can transmit the pumping light irradiated from the pumping light source 150 may be additionally formed thereon.

### Third Embodiment

FIG. 4 is a schematic cross-sectional view of an array-type optical device in accordance with a third embodiment of the present invention.

With reference to FIG. 4, a cladding layer 140a is formed on the substrate 100, and a plurality of linear gain medium structures 120f are formed within the cladding layer 140a. An upper pumping light source 150a is installed above the cladding layer 140a so as to be separated from the cladding layer by a designated distance, and a lower pumping light source 150b is installed below the substrate 100 so as to be separated from the substrate 100 by another designated distance. In order to allow the upper and lower pumping light sources 150a and 150b to pump the gain medium structures 120f, the substrate 100 and the cladding layer 140a are made of a transparent material which can transmit pumping light irradiated from the upper and lower pumped light sources 150a and 150b. Although the plural linear gain medium structures 120f are inserted in the cladding layers 140a in this embodiment of the present invention, the linear gain medium structures 120f may be formed on the external surface of the cladding layer 140a. Instead of increasing the density of the gain medium structures included in the beam spot of the light pumping source, the array-type optical device in accordance with the third embodiment of the present invention increases the number of the pumping light sources, thus generally enhancing its optical pumping efficiency twice as much as the conventional case.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

That is, the array-type optical device achieved by the present invention is not used only in a waveguide amplifier, but also may be used in a passive PIC (Photonic Integrated Circuit) requiring optical gain, such as an optical splitter, an optical demultiplexer, an optical multiplexer, or an AWG (Arrayed Waveguide Grating).

### Industrial Applicability

As apparent from the above description, the present invention provides an array-type optical device which has as many gain medium structures as possible within a beam spot of an optical pumping source or has an increased number of optical pumping sources to irradiate gain medium structures, in order to enhance optical pumping efficiency.

1. An array-type optical device having enhanced pumping efficiency, comprising:
a substrate;
a cladding layer having a plurality of valley portions and ridge portions formed on the substrate;
a plurality of linear gain medium structures, each formed on the surfaces of the valley portions and the ridge portions of the cladding layer, or inserted in the valley portions and the ridge portions of the cladding layer so as to be separated from their surfaces by designated distances; and
a pumping light source disposed above the cladding layer for pumping the gain medium structures by means of light directed downward therefrom.

2. The array-type optical device having enhanced pumping efficiency as set forth in claim 1, wherein the cladding layer is made of a material which can transmit the light irradiated from the pumping light source.

3. The array-type optical device having enhanced pumping efficiency as set forth in claim 1, wherein the pumping light source is a LED.

4. An array-type optical device having enhanced pumping efficiency, comprising:
a substrate;
a lower cladding layer formed on the substrate;
a plurality of linear gain medium structures formed on the lower cladding layer; and
a pumping light source disposed above the linear gain medium structures for pumping the gain medium structures by means of light directed downward there from,
wherein the linear gain medium structures are densely disposed and curved at their terminals so that other portions of the linear gain medium structures are included in the beam spot of the pumping light source.

5. The array-type optical device having enhanced pumping efficiency as set forth in claim 4, further comprising an upper cladding layer formed on the gain medium structures,
wherein the upper cladding layer is made of a material which can transmit the light irradiated from the pumping light source.

6. The array-type optical device having enhanced pumping efficiency as set forth in claim 4, wherein the pumping light source is a LED.

7. An array-type optical device having enhanced pumping efficiency, comprising:
a substrate;
a lower cladding layer formed on the substrate;
a plurality of linear gain medium structures formed on the lower cladding layer; and
upper and lower pumping light sources, each disposed above the upper surfaces of the gain medium structures and below the lower surfaces of the gain medium structures for pumping the gain medium structures by means of light directed downward and upward there from,
wherein the substrate and the lower cladding layer are made of a material which can transmit the light irradiated from the pumping light sources.

8. The array-type optical device having enhanced pumping efficiency as set forth in claim 7, further comprising an upper cladding layer formed on the gain medium structures,
wherein the upper cladding layer is made of a material which can transmit the light irradiated from the pumping light sources.

9. The array-type optical device having enhanced pumping efficiency as set forth in claim 7, wherein the pumping light sources are LEDs.
